(19) United States
(12) Patent Application Publication
(10) Pub. No.: US 2022/0140387 A1
(43) Pub. Date: May 5, 2022

(54) SOLID ELECTROLYTE AND A LITHIUM-ION CONDUCTIVE GLASS-CERAMICS

(71) Applicant: SCHOTT AG, Mainz (DE)

(72) Inventors: Jörg SCHUHMACHER, Kornwestheim (DE); Meike SCHNEIDER, Taunusstein (DE); Wolfgang SCHMIDBAUER, Mainz (DE); Sebastian LEUKEL, Mainz (DE); Andreas ROTERS, Mainz (DE); Martin LETZ, Mainz (DE); Rolf SAMSINGER, Russelsheim am Main (DE)

(73) Assignee: SCHOTT AG, Mainz (DE)

(21) Appl. No.: 17/516,187

(22) Filed: Nov. 1, 2021

(30) Foreign Application Priority Data
Oct. 30, 2020 (EP) 20 204 965.6

(51) Int. Cl. H01M 10/0562; H01M 10/0525; C03C 4/14; C03C 10/00; C03B 19/06

(52) U.S. Cl. CPC H01M 10/0562; H01M 10/0525; C03C 4/14; C03C 2204/00; C03B 19/06; H01M 2300/0077; C03C 10/00

(57) ABSTRACT

The present disclosure relates to a method for producing a solid electrolyte comprising lithium-ion conductive glass-ceramics. The method includes the steps of: providing at least one lithium ion conductor having a ceramic phase content and amorphous phase content; providing a powder of said at least one lithium ion conductor, the powder having a polydispersity index between 0.5 and 1.5, more preferably between 0.8 and 1.3, and most preferably between 0.85 and 1.15; and at least one of a) incorporating the powder into a polymer electrolyte or a polyelectrolyte and b) forming an element using the powder.

### CROSS-REFERENCE TO RELATED APPLICATION

The present application claims the benefit of European Patent Application No. EP 20 204 965.6, filed on Oct. 30, 2020, which is herein incorporated by reference.

### BACKGROUND OF THE DISCLOSURE

### 1. Field of the Disclosure

The present disclosure relates to a method for producing a solid electrolyte comprising lithium-ion conductive glass-ceramics.

The present disclosure further relates to a lithium-ion conductive glass-ceramics powder comprising at least one lithium ion conductor.

The present disclosure further relates to a solid electrolyte.

The present disclosure even further relates to a battery, preferably an all solid state battery or a lithium-air battery, comprising at least one battery component.

The present disclosure even further relates to a system for producing a solid electrolyte comprising lithium-ion conductive glass-ceramics.

### 2. Discussion of the Related Art

Batteries, for instance lithium ion batteries, are used in many different devices, in particular in portable devices like laptops, smartphones or the like, for providing electrical energy for those devices. Meanwhile, lithium ion batteries are also used in electric vehicles for providing electrical energy to the engine, i.e. one or more electric motors. Although classical lithium ion batteries already have a high energy density, the provided energy density is too low to allow a large driving range, one comparable to the driving range of a combustion engine. Known lithium ion batteries have already an energy density, which is near the theoretical maximum. Solid state batteries may have the potential to overcome the limits of today's Lithium ion batteries. Replacing a liquid electrolyte by a solid electrolyte may enable new high energy density electrode materials like Lithium metal anodes. To achieve good cell performance a high ion conductivity of the solid electrolyte is important. Therefore, another focus is the conductivity of a lithium ion based battery, which is still rather low.

Embodiments of the disclosure therefore address the problem of providing a higher conductivity of lithium-ion conductive glass-ceramics, a solid electrolyte and a battery. Embodiments of the disclosure address the further problem of providing a cost effective method for manufacturing and a corresponding system. Embodiments of the disclosure address the further problem of providing an alternative lithium-ion conductive glass-ceramics, an alternative solid electrolyte and an alternative battery and an alternative method for manufacturing as well as an alternative system.

### SUMMARY OF THE DISCLOSURE

In an embodiment, the present disclosure provides a method for producing a solid electrolyte comprising lithium-ion conductive glass-ceramics. The method comprises the steps of:
providing at least one lithium ion conductor having a ceramic phase content and amorphous phase content;
providing a powder of said at least one lithium ion conductor, said powder having a polydispersity index between 0.5 and 1.5, preferably between 0.8 and 1.3, and more preferably between 0.85 and 1.15; and
a) incorporating said powder into a polymer electrolyte or a polyelectrolyte and/or
b) forming an element using said powder.

In a further embodiment, the present disclosure provides a lithium-ion conductive glass-ceramics powder comprising at least one lithium ion conductor, with said at least one ion conductor comprising a ceramic phase content and amorphous phase content, wherein said at least one ion conductor has said powder having a polydispersity index between 0.5 and 1.5, preferably between 0.8 and 1.3, and more preferably between 0.85 and 1.15.

In a further embodiment, the present disclosure provides a battery, preferably an all solid state battery or a lithium-air battery, comprising at least one battery component. The at least one battery component comprises a solid electrolyte.

In a further embodiment the present disclosure provides a system for producing a solid electrolyte comprising lithium-ion conductive glass-ceramics, preferably for performing with the above-described method. The system comprises:

a first provision entity adapted to provide at least one lithium ion conductor having a ceramic phase content and amorphous phase content;

a second provision entity adapted to provide a powder of said at least one lithium ion conductor, said powder having a polydispersity index between 0.5 and 1.5, preferably between 0.8 and 1.3, and more preferably between 0.85 and 1.15; and
a) an incorporating entity adapted to incorporate said powder into a polymer electrolyte or a polyelectrolyte and/or
b) a forming entity adapted to form an element using said powder.

### BRIEF DESCRIPTION OF THE DRAWINGS

FIGS. 1a and 1b show an X-ray diffraction diagram of glass ceramic LATP particles and glass ceramic LLZO particles, respectively.

FIGS. 2a and 2b show Nyquist diagrams of Au-LATP-Au and Au-LLZO-Au, respectively.

FIG. 3 shows steps of a method according to an embodiment of the present disclosure.

### DETAILED DESCRIPTION OF THE DISCLOSURE

One of the advantages of the present disclosure is that a higher conductivity of the lithium-ion conductor glass ceramics can be obtained compared to conventional lithium ion conductor glass-ceramics, in particular for the grain-core conductivity.

The term “polydispersity index” relating to the particle size distribution is to be understood as common logarithm (logarithm with base 10) of the quotient of the d₉₀- and d₁₀-value of the diameter distribution: PI=log(d₉₀/d₁₀).

The term “d-value” as basis for the d₉₀-value and d₁₀-value is determined as follows:

Independently of their real sphericity, the particles of a powder are generally distinguished with the aid of a volume-equivalent sphere diameter, which has to be measured, and are ordered into selected classes according to their size. To represent a particle size distribution, a determination is made of the quantity fractions with which the respective classes of particle are present in the powder.

This is done using different quantity types. If the particles are counted, the quantity type is the number. In the case of weightings, conversely, it is the mass or, in the case of homogeneous density Qᵣ, the volume. Other types are derived from lengths, projection surfaces and surface areas.

The following are distinguished:

| Quantity type: | Index r: |
|---|---|
| Number | 0 |
| Length | 1 |
| Area | 2 |
| Volume (mass) | 3 |

One common quantity measure for describing the particle size distribution in powders is formed by the cumulative distribution Qᵣ. The index r identifies the quantity type according to the table above.

The cumulative distribution function Qᵣ (d) indicates the standardized quantity of all particles having an equivalent diameter less than or equal to d. Explicitly defined below are cumulative distributions of the two most commonplace quantity types:

Particle Number (r=0).

Let Nᵢ be the number of all particles investigated with a diameter d less than or equal to the diameter dᵢ under consideration and let N be the total number of all particles investigated. In that case

$${Q}_{0} ( {d}_{i} ) = \frac{{N}_{i}}{N}$$

Particle Mass (r=3).

Let mi be the mass of all particles investigated with a diameter d less than or equal to the diameter dᵢ under consideration, and let m be the total mass of all particles investigated. In that case

$${Q}_{3} ( {d}_{i} ) = \frac{{m}_{i}}{m}$$

In the sense of the disclosure, dᵢ values are understood to be equivalent diameter values for which the Q₃ (dᵢ) cumulative distribution function adopts the following values:
d₁₀: Q₃ (d₁₀)=10%, i.e. 10 weight.-% of the particles have a diameter less than or equal to d₁₀.
d₅₀: Q₃ (d₅₀)=50%, i.e. 50 weight.-% of the particles have a diameter less than or equal to d₅₀.
d₉₀: Q₃ (d₉₀)=90%, i.e. 90 weight.-% of the particles have a diameter less than or equal to d₉₀.
d₉₉: Q₃ (d₉₉)=99%, i.e. 99 weight.-% of the particles have a diameter less than or equal to d₉₉.
d₁₀₀: Q₃ (d₁₀₀)=100%, i.e. 100 weight.-% of the particles have a diameter less than or equal to d₁₀₀.

In the sense of the present specification, the term “polydispersity index” may be understood synonymously with the term “polydispersion index”.

Further features, advantages and preferred embodiments are disclosed or may become apparent in the following.

According to an embodiment prior to step b), a step c) of pressing said powder to obtain a pellet as precursor for said element is performed. This can enhance forming an element using said powder.

According to a further embodiment prior to step b), a step d) of incorporating said powder into a ceramic precursor composition, preferably a slip, is performed. This can enable to perform a casting forming process, for instance a film casting process, to prepare an element for sintering afterwards.

According to a further embodiment in step d) at least one binding agent is added. This can enable a fine and enhanced control of the casting forming process.

According to a further embodiment, said element is sintered. Sintering enables providing a solid element although the precursors of the element do not chemically bind to one another.

According to a further embodiment, said at least one lithium ion conductor is provided comprising at least one of:
One or more ion lithium conductors having a garnet type structure, preferably LLZO, lithium niobium garnet, lithium tantalum garnet and/or lithium aluminum garnet, preferably according to the general formula

Li_{7-3x+y′+2y″-z′-2z″}Alₓ³⁺La_{3-y-y′-y″}M_{y}³⁺M_{y′}²⁺M_{y″}¹⁺Zr_{2-z-z′-z″}M_{z}⁴⁺M_{z′}⁵⁺M_{z″}⁶⁺O_{12+/-δ},
wherein M³⁺ represents one or more trivalent cations having an ion radius smaller than La³⁺, without Al³⁺, M²⁺ represents one or more bivalent cations, M¹⁺ represents one or more monovalent cations except Li⁺, M⁴⁺ represents one or more tetravalent cations except Zr⁴⁺, M⁵⁺ represents one or more pentavalent cations, and wherein M⁶⁺ represents one or more hexavalent cations, and wherein 0.1≤x<1, 0<y<2, 0≤y′<0.2, 0≤y″<0.2, 0≤y′+y″<0.2, 0≤z<0.5, 0≤z′<0.8, 0≤z″<0.5, 0≤δ≤2,
One or more lithium ion conductors having a NASICON type structure, preferably LATP—Li_{1.3}Al_{0.3}Ti_{1.7}P₃O₁₂, LAGP—Li_{1.5}Al_{0.5}Ge_{1.5}(PO₄)₃ or any combination thereof,
One or more lithium ion conductors having a perovskite type structure, preferably LLT—Li₃ₓLa_{2/3-x}TiO₃,
One or more lithium ion conductors having a spinel structure,
One or more lithium ion conductors having a LISICON-type structure, preferably lithium zinc germanate.

An advantage can be that a simple ion conductor is provided having a high conductivity at room temperature and being electrochemically stable.

According to a further embodiment, said ceramic phase content is the main content of said lithium ion conductor. This can provide an even higher conductivity of the solid electrolyte.

According to a further embodiment of the lithium-ion conductive glass-ceramics powder, said ceramic phase content is the main content of said lithium ion conductor. This can provide an even higher conductivity of the solid electrolyte.

According to a further embodiment of the lithium-ion conductive glass-ceramics powder, the volume based median particle size of said powder is below 2 micrometers, preferably below 1.5 micrometers, preferably below 1.0 micrometers. This can enable to provide particles with a low diameter enabling an easier sintering process.

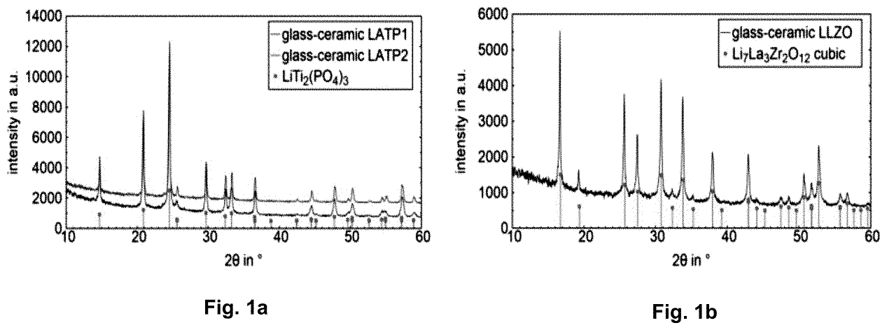

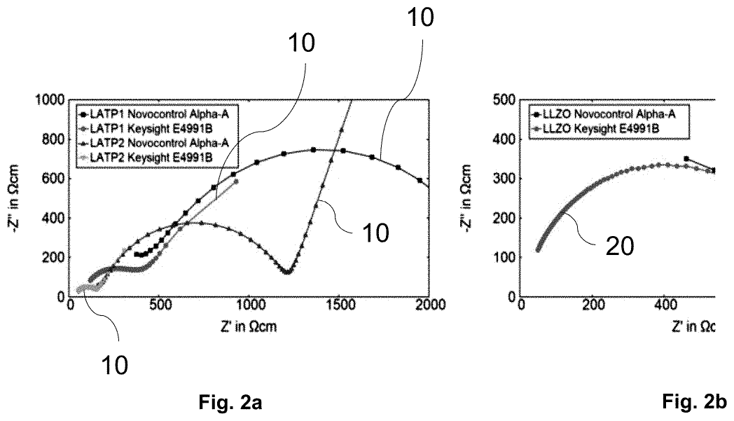

According to a further embodiment of the lithium-ion conductive glass-ceramics powder, said lithium-ion conductive glass-ceramics powder having a grain-core conductivity of more than 0.75 mS/cm, preferably more than 1.5 mS/cm, preferably more than 2.3 mS/cm, preferably more than 5 mS/cm, preferably more than 6 mS/cm, and/or a grain-boundary conductivity of more than 0.5 mS/cm, more preferably more than 0.75 mS/cm, and most preferably more than 0.9 mS/cm. This can allow a high conductivity of the lithium-ion conductive glass-ceramics powder enhancing the fields of application of end products based on said powder as well as their properties. The conductivity as described here was measured using a CRT-method as described in detail below in connection with FIGS. 1a, 1b, 2a and 2b.

According to a further embodiment of the lithium-ion conductive glass-ceramics powder, said at least one lithium ion conductor has an overall density lower than the density of said lithium ion conductor having only a ceramic phase, preferably wherein said overall density is at least 2.5% lower, preferably at least 3.0% lower, more preferably at least 3.5% lower, and most preferably by at least 5% lower. This can allow to enhance the gravimetric energy density even further.

According to a further embodiment of the lithium-ion conductive glass-ceramics powder, the purity of said ceramic phase volume content of said at least one lithium ion conductor is at least 95%, more preferably more than 97%, and most preferably more than 99%. This may allow an even further enhancement of the conductivity, since the forming of unwanted substances like AlPO₄ enriched phases at the grain-boundaries for LATP-based lithium ion conductive glass ceramic powder can be reduced.

The term “purity of the ceramic phase” according to the present disclosure is to be understood as being the ratio of the amount of ion conducting phase in vol % to the total amount of the crystalline phases of the lithium-ion conductive glass-ceramics powder. For instance the ion conducting phase of the at least one lithium ion conductor has to be at least 95 vol % of the total amount of the crystalline phases present in the glass-ceramic and the amount of other, in particular presumably unwanted, crystalline phases has to be less than 5 vol %. This ratio can be determined for example by evaluation of XRD data using the Rietveld method.

According to a further embodiment of the battery, said battery comprises at least two electrodes, wherein said at least one battery component is a separator separating said at least two electrodes. This can have the advantage of providing a separator element for a battery based on the solid electrolyte avoiding short circuits within the battery.

According to a further embodiment of the battery, said separator is arranged on a surface of at least one of said at least two electrodes and/or said separator is provided in form of a free-standing membrane. This can have the advantage of providing a separator in a flexible way.

There are several ways how to design and further develop the teaching of the present disclosure in an advantageous way. To this end, it is to be referred to the patent claims subordinate to the independent claims and to the following explanation of further examples of embodiments of the disclosure, illustrated by the drawings. In connection with the explanation of the further embodiments of the disclosure by the aid of the drawing, generally further embodiments and developments of the teaching will be explained.

To determine the conductivity of elements comprising or being manufactured of a lithium-ion conductive glass-ceramics powder, the coaxial reflection technique—CRT in the following—is used. Using CRT enables to obtain knowledge about the underlying conductivity mechanisms also considering the local microstructure e.g. pores, grain-boundaries and the preparation conditions in particular for fast ionic conductors, i.e. σ>10⁻⁴ S/cm compared with Electrochemical Impedance Spectroscopy—EIS—and Nuclear Magnetic Resonance—NMR. Especially CRT enables to determine the relative permittivity more accurately at room temperature. Furthermore, the advantage of amorphous phase assisted sintering is shown in the following for two glass-ceramic LATP and one LLZO sample. For a 100% dense LATP sample CRT reveals a high grain-core conductivity of 6×10⁻³ S/cm similar to the conductivity of ideal single crystals.

For example, LATP is known to have high grain-core conductivity, but high resistance pathways along grain-boundaries. Electrochemical impedance spectroscopy—EIS—measurement setups are capable to measure up to several MHz. At room temperature, the grain-core conductivity of LATP is too high to be well resolved. Therefore, measurements have to be performed below room temperature to detect both the grain-core and grain-boundary process and extrapolate via the Arrhenius law leading to uncertainties. Alternatively, sample geometry has to be changed, e.g. by increasing the thickness and decreasing the electrode area. Via NMR different processes can be detected on several timescales, however, conversion from NMR diffusion coefficients to the more relevant conductivity is cumbersome. This is regularly done via the Nernst-Einstein equation, which strictly only applies for conductors with non-interacting charge carriers. Although this is the case for dilute liquid solutions, deviations will occur for solid ion conductors. Additionally, the average jump distance is a crucial parameter. Yet, experimental estimation is a significant error source. A further disadvantage is that calculated activation energies typically differ from the ones obtained from EIS measurements.

To prove the feasibility of the CRT-method, two glass-ceramic LATP powders and one glass-ceramic LLZO powder were sintered and measured via classical EIS and a coaxial reflection technique CRT.

Furthermore, in the following it is shown that amorphous phase assisted sintering is a successful strategy to obtain dense samples with very high conductivity.

### Sample Preparation

These powders were obtained from a unique melting route at semi-industrial scale. Thus, inhomogeneity effects of different batches are less pronounced.

The glass-ceramic lithium ion conductors Li_{1.3}Al_{0.3}Ti_{1.7}P₃O₁₂ (LATP) and Li₇La₃Zr₂O₁₂ (LLZO) were produced via melting routes at the SCHOTT AG. As glass-ceramics, these ion conductors comprise both a ceramic and a unique amorphous phase. Two different LATP powders with the same crystalline stoichiometry, but different content of amorphous phase are produced.

In the following production of the two LATP powders, named LATP-1 and LATP-2 is described in detail:

### LATP-1:

A precursor glass composition for a lithium ion conductive phosphate based glass ceramics LATP-1 was melted as described for the highly conductive boron-free reference samples in DE 10 2018 102 387 B3, which is herein incorporated by reference.

Subsequently, the glass was ceramized and the as-obtained glass-ceramic was crushed and grinded in different comminution steps. The particles in the resulting powder had a diameter of 0.30 μm, 50% by weight a diameter of approximately 1.09 μm, 90% by weight a diameter of approximately 2.83 μm and 99% by weight a diameter of approximately 4.56 μm. In this case, the polydispersity index accordingly has a value of 0.97. The particle sizes were measured using the method of static light scattering according to ISO 13320 (2009) with a particle size measuring instrument of the company CILAS of type 1064. The measurement was carried out in water as medium and evaluated according to the Fraunhofer method.

The slurry was dried on a rotary evaporator. From the obtained powder, compacts were produced and sintered at 1000° C. for 12 hours. The conductivity of the sintered compacts was then determined.

### LATP-2:

A precursor glass composition for a lithium ion conductive phosphate-based glass ceramic LATP-2 was melted as described for the highly conductive boron-containing reference samples in DE 10 2018 102 387 B3, which is herein incorporated by reference.

Subsequently, the glass was ceramized and the as-obtained glass-ceramic was crushed and grinded in different comminution steps. The particles in the resulting powder had a diameter of 0.28 μm, 50% by weight a diameter of approximately 1.01 μm, 90% by weight a diameter of approximately 2.84 μm and 99% by weight a diameter of approximately 4.68 μm. In this case, the polydispersity index accordingly has a value of 1.00. The particle sizes were measured using the method of static light scattering according to ISO 13320 (2009) on a particle size measuring device of the company CILAS of type 1064. The measurement was carried out in water as medium and evaluated according to the Fraunhofer method.

The slurry was dried on a rotary evaporator. From the obtained powder compacts were produced and sintered at 800° C. for 12 hours. The conductivity of the sintered compacts was then determined.

### LLZO:

A precursor glass composition for a lithium ion conductive garnet based glass ceramic LLZO was melted as described in DE 10 2014 100 684 A1, which is herein incorporated by reference.

Subsequently, the cooled melt was crushed and grinded in different comminution steps. The particles in the resulting powder had a diameter of about 0.36 μm (10 weight.-%), a diameter of about 1.14 μm (50 weight.-%), a diameter of about 2.52 μm (90 weight.-%) and a diameter of about 3.80 μm (99 weight.-%). In this case, the polydispersity index accordingly has a value of 0.85. The particle sizes were measured using the method of static light scattering according to ISO 13320 (2009) on a particle size measuring instrument of the company CILAS of type 1064. The measurement was carried out in water as medium and evaluated according to the Fraunhofer method.

From the powder obtained in this way, compacts were produced and sintered at 1130° C. for 30 min. The conductivity of the sintered compacts was then determined.

In addition, the conduction mechanism is in the following compared to a LLZO sample. LLZO has the disadvantage that the high conductive cubic modification was stabilized at room temperature.

Compared to pure ceramic LATP and LLZO, the skeleton density of glass-ceramic LATP and LLZO is reduced, due to the lower density of the amorphous phase. The LATP with low amorphous phase content will be denoted as LATP-1 in the following. It has a skeleton density of 2.86 g/cm³, which is close to the pure ceramic density of 2.90 g/cm³. The LATP with high amorphous phase content has a skeleton density of 2.80 g/cm³ denoted as LATP-2 in the following. The difference in density is more significant for glass-ceramic LLZO with 4.84 g/cm³ compared to the ideal density of 5.10 g/cm³. Amongst all powders, the volume based median particle size is 1 μm or below. The particle size distributions are rather narrow. The powders were pressed to discs with a diameter of 10 mm and a thickness of 1 to 2 mm. Afterwards the discs were sintered. Finally, the sintered discs were transferred into an argon-filled glove box and polished with sandpaper.

### Sample Measurements

Prior to the measurements, the samples have been sputtered with gold to ensure sufficient electric contact. Conventional EIS has been performed with a Novocontrol Alpha-A Analyzer with a voltage amplitude of 20 mV in the frequency range of 0.1 Hz until 20 MHz. A sealed measurement cell was used to avoid contact of the LLZO with air. ZView2 of Scribner Associates Inc. was used for fitting. Then a Keysight E4991B Impedance Analyzer in the frequency range of 1 MHz to 3 GHz was used for the reflection measurement of the dielectric halfspace with an open-ended probe, i.e. skin depth>>thickness of the probe. As ion-conductors, in contrast to low-loss dielectric ceramics, have a higher dielectric-loss, i.e. due to the desired ionic motion, the additional dielectric-loss in the gold-layers does not deteriorate the results.

Since at frequencies between 1 GHz and 3 GHz, a series inductance dominates the measurement due to the metallic connections and at room temperature the frequency range above 1 GHz is yet of no interest for evaluation, the highest frequencies containing no sample information, were neglected. All measurements were performed in air.

### Results

### Structural Analysis

For a high conductivity, the purity of the ceramic phase content of LATP and LLZO should be high. For example, LATP forms AlPO₄ (JCPDS: 00-011-0500) enriched phases at grain-boundaries or unwanted TiO₂ (JCPDS: 00-088-1175, 00-084-1286) impurity phases. LLZO samples are even more sensitive. Besides the tetragonal LLZO phase, La₂Zr₃O₇(JCPDS: 01-075-03446) and Li₂CO₃ (JCPDS: 01-083-1454) are known insulating impurity phases. The XRD of glass-ceramic LATP-1, LATP-2, and LLZO is shown in FIGS. 1a and 1b.

Only the LTP phase and the cubic LLZO phase can be detected without any additional impurities. Consequently, a high conductivity is to be expected. Furthermore, for the LATP-1 and LATP-2 the effect of the different amorphous phase content can be investigated without perturbations from any impurities.

### Morphological Analysis

The open porosity of pressed pellets was detected to be about 34%. However, after sintering LATP-1 samples still have a low geometrical density (solids concentration) of about 66 to 70%. In contrast, the LATP-2 samples expose a shrinkage leading to high densities of up to nearly 100%, i.e. nearly no pores. Also for the LLZO samples, the amorphous phase leads to high densities of 95 to 97%.

### Electrochemical Performance

The combined normalized impedance data obtained from the conventional EIS measurement with the Novo-control Alpha-A analyzer and the high-frequency CRT measurement with the Keysight E4991B is shown in FIGS. 2a and 2b. The impedance has been normalized with respect to the area and thickness of the samples for comparison, due to the different shrinkage.

At low frequencies, the blocking of lithium ions is visible. This leads to a straight line of constant slope. A deviation from 90° versus the abscissa Z′ can be interpreted as an effect from a rough electrode surface with microscopic inhomogeneities.

For the LATP-1 (reference signs 101, 102) and LATP-2 (reference signs 103, 104) samples, conventional EIS resolves a depressed semicircle, i.e. a resistor in parallel with a constant-phase-element (CPE), at intermediate frequencies (reference signs 101, 103).

The obtained capacities at intermediate frequencies are in the order of 10⁻⁹ F. Capacitances in the nF-regime can be interpreted as a grain-boundary process. At high frequencies, the resistance from origin indicates another process. It is rather difficult to fit this process with another semi-circle accurately.

In contrast, CRT is capable to resolve this semi-circle at room temperature. For LATP-1 (reference signs 102, 104) there is a very small deviation of the impedance compared to the EIS-data (reference signs 101, 103). Due to experimental limitations, the thickness and diameter of this sample are at the upper limit that is acceptable for the metallic fixture of the sample holder. Nevertheless, the grain-core, also called “bulk” semi-circle is well resolved and the capacitance is in the order of 10⁻¹¹ F.

The conductivity of the sintered discs can be calculated according to the following equation:

$$σ = \frac{1}{R} \cdot \frac{t}{A} \qquad ( 1 )$$

In the equation R is the fitted resistance, t is the thickness of the sample, and A is the electrode area. For LATP-1 101, 102 the grain-boundary conductivity from EIS is 5.04×10⁻⁴ S/cm with a grain-core conductivity of 2.37×10⁻³ S/cm. The grain-core conductivity obtained from the CRT is 2.15×10⁻³ S/cm. LATP-2 103, 104 has a grain-boundary conductivity of 9.49×10⁻⁴ S/cm and a high grain-core conductivity of 6.00×10⁻³ S/cm, which matches well with the one obtained from the CRT setup of 5.91×10⁻³ S/cm. Therefore, both grain-core and grain-boundary conductivity increase with density.

Additionally, the results of LATP-2 103, 104 can be compared to the glass-ceramic LLZO 201, 202. Similarly, the amorphous phase leads to a high relative density. For LLZO in FIG. 2b only one semi-circle is visible even with the extension to the GHz regime. The capacitance is in the order of 10-11 F and can be identified with the bulk process. The conductivity of LLZO obtained from EIS is 8.29×10⁻⁴ S/cm (reference sign 201) and the one from the CRT is 8.23×10⁻⁴ S/cm (reference sign 202). These values are within a similar order of magnitude compared to other LLZO with high relative density.

Regarding both measurement methods, either EIS or CRT, the resulting conductivity values are similar. However, for the EIS measurement one has to assume, that no other processes in the unresolved high-frequency regime are present.

The high-frequency relative permittivity (dielectric constant) ∈r can be derived via the following equation:

$${ϵ}_{R} = \frac{1}{i {ωϵ}_{0}} \cdot \frac{1}{Z} \qquad ( 2 )$$

with the vacuum permittivity ∈₀=8.85419×10⁻¹² F/m and the imaginary unit i=\sqrt{−1}. As the normalized impedance Z can be fitted precisely, the limited frequency range of the EIS setup leads to an inaccurate high-frequency relative permittivity.

In contrast, via CRT the fast ionic transport processes are well resolved at room temperature. Hence, both conductivity and high-frequency relative permittivity can be determined precisely.

In the following table the calculated relative permittivities of the EIS and CRT are compared. The different relative permittivities of LATP-1 and LATP-2 samples might be explained with their microstructure.

Estimation of the relative permittivity according to equation 2

| | Relative permittivity | Relative permittivity |
|---|---|---|
| | from EIS | from CRT |
| LATP-1 | 73.78 | 32.20 |
| LATP-2 | 106.17 | 76.83 |
| LLZO | 72.87 | 93.31 |

Nevertheless, significant differences arise from the limited resolution of EIS. Furthermore, the values were highly temperature-dependent due to the limited frequency range of the EIS.

To conclude, measurements using the coaxial reflection technique enable accurate measurements expanding the measurement range of conventional electrochemical impedance spectrometers. As a result, the ultra-fast conductivity processes at high frequencies could be resolved and interpreted, complementing first estimations from NMR or microelectrode measurements. Furthermore, reliable high-frequency relative permittivities can be calculated accurately at room temperature.

Amorphous-phase assisted sintering allows obtaining electrolytes with enhanced microstructure and a relative density of up to 100%. By optimizing the amorphous phase, glass-ceramic LATP has a high grain-boundary conductivity close to 10⁻³ S/cm. Moreover, the resolved grain-core conductivity of 6×10⁻³ S/cm matches well with the data known from single-crystals, demonstrating the feasibility of the coaxial reflection technique.

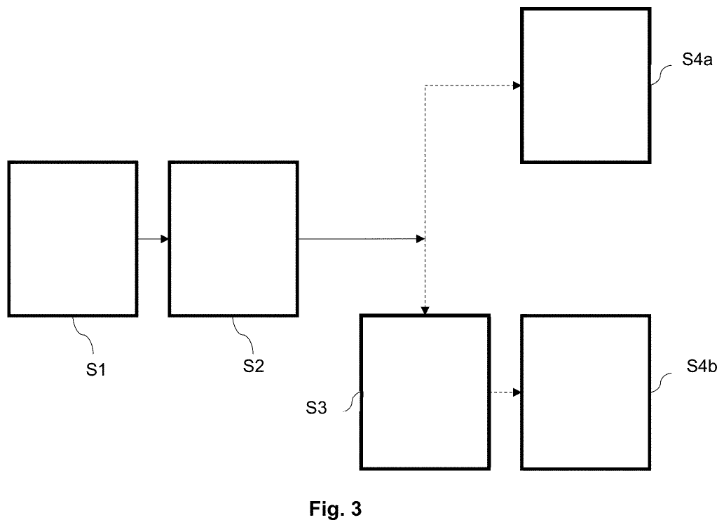

FIG. 3 shows steps of a method according to an embodiment of the present disclosure.

In detail, steps of a method for producing a solid electrolyte comprising lithium-ion conductive glass-ceramics are shown.

The method comprises the following steps
Providing S1 at least one lithium ion conductor having a ceramic phase content and amorphous phase content,
Providing S2 a powder of said at least one lithium ion conductor, said powder having a polydispersity index between 0.5 and 1.5, preferably between 0.8 and 1.3, preferably between 0.85 and 1.15, and
a) Incorporating S4a said powder into a polymer electrolyte or a polyelectrolyte and/or
b) Pressing S3 said powder to obtain a pellet as precursor for said element is performed and
c) Forming S4b an element using said powder.

To summarize, at least one of the embodiments of the present disclosure can enable the following advantages or provides or enables the following features
high overall conductivity
measurement of ultra-fast conductivity processes at high frequencies
simple and cost-effective implementation
solid state electrolyte having a high conductivity, in particular very high grain-core conductivity above 5 mS/cm

Many modifications and other embodiments of the disclosure set forth herein will come to mind to the one skilled in the art to which the disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### LIST OF REFERENCE SIGNS

101, 102 Complex impedance of LATP-1
103, 104 Complex impedance of LATP-2
201, 202 Complex impedance of LLZO

What is claimed is:

1. A method for producing a solid electrolyte comprising lithium-ion conductive glass-ceramics, the method comprising the steps of:
providing at least one lithium ion conductor having a ceramic phase content and amorphous phase content;
providing a powder of the at least one lithium ion conductor, the powder having a polydispersity index between 0.5 and 1.5; and
at least one of steps:
a) incorporating the powder into a polymer electrolyte or a polyelectrolyte; and
b) forming an element with the powder.

2. The method according to claim 1, wherein step b) is performed, and the method further comprises, prior to step b), a step c) of pressing the powder to obtain a pellet as precursor for the element is performed.

3. The method according to claim 1, wherein step b) is performed, and the method further comprises, prior to step b), a step d) of incorporating the powder into a ceramic precursor composition.

4. The method of claim 3, wherein the precursor composition is a slip and during step d) at least one binding agent is added to the precursor composition.

5. The method according to claim 1, wherein step b) is performed, and the method further comprises sintering the element.

6. The method according to claim 1, wherein the at least one lithium ion conductor comprises at least one of:
one or more ion lithium conductors having a garnet type structure;
one or more lithium ion conductors having a NASICON type structure;
one or more lithium ion conductors having a perovskite type structure;
one or more lithium ion conductors having a spinel structure; and
one or more lithium ion conductors having a LISICON-type structure.

7. The method of claim 6, wherein the at least one lithium ion conductor comprises at least one or more ion lithium conductors having a garnet type structure according to the formula:
Li_{7-3x+y′+2y″-z′-2z″}Alₓ³⁺La_{3-y-y′-y″}M_{y}³⁺M_{y′}²⁺M_{y″}¹⁺Zr_{2-z-z′-z″}M_{z}⁴⁺M_{z′}⁵⁺M_{z″}⁶⁺O_{12+/-δ},
wherein M³⁺ represents one or more trivalent cations having an ion radius smaller than La³⁺, without Al³⁺, M²⁺ represents one or more bivalent cations, M¹⁺ represents one or more monovalent cations except Li⁺, M⁴⁺ represents one or more tetravalent cations except Zr⁴⁺, M⁵⁺ represents one or more pentavalent cations, and wherein M⁶⁺ represents one or more hexavalent cations, and wherein 0.1≤x<1, 0<y<2, 0≤y′<0.2, 0≤y″<0.2, 0≤y′+y″<0.2, 0≤z<0.5, 0≤z′<0.8, 0≤z″<0.5, 0≤δ<2.

8. The method according to claim 1, wherein the ceramic phase content is the majority content of the lithium ion conductor.

9. A lithium-ion conductive glass-ceramics powder comprising at least one lithium ion conductor, wherein the at least one lithium ion conductor comprises a ceramic phase content and amorphous phase content, and wherein the powder has a polydispersity index between 0.5 and 1.5.

10. The lithium-ion conductive glass-ceramics powder according to claim 9, wherein the polydispersity index is between 0.8 and 1.3.

11. The lithium-ion conductive glass-ceramics powder according to claim 9, wherein the ceramic phase content is the majority content of the lithium ion conductor.

12. The lithium-ion conductive glass-ceramics powder according to claim 9, having a volume based median particle size, wherein the volume based median particle size of the powder is below 2 micrometers.

13. The lithium-ion conductive glass-ceramics powder according to claim 9, the lithium-ion conductive glass-ceramics powder having a grain-core conductivity of more than 0.75 mS/cm, and/or a grain-boundary conductivity of more than 0.5 mS/cm.

14. The lithium-ion conductive glass-ceramics powder according to claim 13, wherein the grain-core conductivity is more than 6 mS/cm and/or a grain-boundary conductivity of more than 0.9 mS/cm.

15. The lithium-ion conductive glass-ceramics powder according to claim 9, wherein the at least one lithium ion conductor has an overall density lower than the density of a lithium ion conductor having only a ceramic phase.

16. The lithium-ion conductive glass-ceramics powder according to claim 9, wherein a purity of the ceramic phase content of the at least one lithium ion conductor is at least 95%.

17. The lithium-ion conductive glass-ceramics powder according to claim 9, wherein the at least one ion conductor comprises at least one of:
one or more ion conductors having a garnet type structure;
one or more ion conductors having a NASICON type structure;
one or more ion conductors having a perovskite type structure;
one or more ion conductors having a spinel structure; and
one or more ion conductors having a LISICON-type structure.

18. A solid electrolyte manufactured with the method of claim 1.

19. A battery comprising at least one battery component, the at least one battery component comprising a solid electrolyte according to claim 1.

20. A system for producing a solid electrolyte comprising lithium-ion conductive glass-ceramics for performing the method according to claim 1, comprising:
a first provision entity adapted to provide at least one lithium ion conductor having a ceramic phase content and amorphous phase content;
a second provision entity adapted to provide a powder of the at least one lithium ion conductor, the powder having a polydispersity index between 0.5 and 1.5; and
at least one of:
a) an incorporating entity adapted to incorporate the powder into a polymer electrolyte or a polyelectrolyte; and
b) a forming entity adapted to form an element using the powder.
